(19) United States
(12) Patent Application Publication
(10) Pub. No.: US 2017/0302479 A1
(43) Pub. Date: Oct. 19, 2017

(54) METHOD AND SYSTEM FOR CARRIER FREQUENCY OFFSET ESTIMATION IN LTE MTC DEVICE COMMUNICATION

(71) Applicant: SIERRA WIRELESS, INC., Richmond (CA)

(72) Inventors: Naveen MYSORE BALASUBRAMANYA, Vancouver (CA); Lutz Hans-Joachim LAMPE, Vancouver (CA); Gustav Gerald VOS, Surrey (CA); Steven John BENNETT, Coquitlam (CA)

(21) Appl. No.: 15/455,286

(22) Filed: Mar. 10, 2017

Related U.S. Application Data
(60) Provisional application No. 62/307,327, filed on Mar. 11, 2016.

(51) Int. Cl. H04L 25/02; H04L 1/00; H04L 29/08; H04L 5/00; H04J 11/00

(52) U.S. Cl. CPC H04L 25/022; H04L 67/12; H04L 5/005; H04L 1/0054; H04J 11/00

(57) ABSTRACT

The present technology provides a system and methods for carrier frequency offset (CFO) estimation. According to embodiments, there is provided a system and method for CFO estimation for narrow band 3GPP LTE/LTE-A Machine Type Communication (MTC) uplinks.

### CROSS-REFERENCE TO RELATED APPLICATIONS

This application claims the benefit of U.S. Provisional Application Ser. No. 62/307,327 titled “Method and System for Carrier Frequency Offset Estimation in LTE MTC Device Communication” filed on Mar. 11, 2016, which is incorporated by reference herein in its entirety.

### FIELD OF THE INVENTION

The present invention pertains in general to carrier frequency offset (CFO) estimation, and CFO estimation for narrow band 3GPP LTE/LTE-A Machine Type Communication (MTC) uplinks.

### BACKGROUND

Current work on additions to the Third Generation Partnership Project (3GPP™) standard for wireless communication includes design of new categories of user equipment optimized for the “Internet of Things” (IoT). Features of these new categories of devices include lower cost, smaller amounts of data to be communicated, infrequent communication, long battery life objectives and enhanced coverage. These features require re-design of many details of the communications standard to accommodate these new categories of devices. Release 12 of the 3GPP standard defined Category 0 with lower data rates than previous categories. Release 13 will define Category M1 operating in a narrow bandwidth within LTE. Release 13 will also define narrow band IoT (NB-IoT) with an even narrower bandwidth capability and lower data rates. NB-IoT will also be able to stand alone in a 200 kHz band independent of an LTE base station. This is being designed for deployment in “re-farmed” GSM channels. The enhanced coverage features require communication with as little as 20 dB less signal strength than the current minimum. This is intended to allow connection not just far from a base station but deep inside buildings such as in the basement or down a manhole below street level. This additional coverage is being achieved in part by repetition of transmissions, which uses more time to send a given amount of data and is therefore less efficient. Since user equipment (UEs) of the new categories will in many cases connect to the base station only infrequently it is also important that they will be able to establish a connection quickly even in weak signal conditions to minimize battery usage.

The new category, NB-IoT, can be able to be assigned use of 1, 3 or 6 uplink sub-carriers as well as the previous minimum of 12 sub-carriers that form a Physical Resource Block (PRB). In the terminology of the standards work, and as used herein, “tones” are used to describe the subcarriers. The smaller number of tones enables power spectral density (PSD) boosting because the available transmitter power is spread over fewer carriers. Using only one tone also enables the use of a modulation scheme that has low peak-to-average power which also enables the use of a more power efficient non-linear RF power amplifier and a higher average transmitted power. These features can help improve the signal strength as a way to achieve more reliable communication in enhanced coverage.

One of several challenges of connecting at very low signal levels is to adjust for the carrier frequency offset (CFO) of the user equipment. The base stations need to be able to determine and adjust for the offset of the carrier frequency to within acceptable limits as quickly and reliably as possible. Work has been performed in evaluating 100 Hz carrier frequency offset (CFO). Studies have shown advantages in achieving 10 Hz CFO that allow for 20% to 32% fewer repetitions of a transport block. For example, the Transport Block Size (TBS) values in TABLE 1 below represent values expected for MTC communication.

TABLE 1

| TBS | CFO = 100 Hz | CFO = 10 Hz | Improvement |
|---|---|---|---|
| 72 | 110 | 80 | 20% |
| 144 | 200 | 144 | 28% |
| 224 | 304 | 216 | 29% |
| 328 | 376 | 256 | 32% |
| 424 | 448 | 304 | 32% |

In the current implementations of LTE, CFO is estimated using auto-correlation of the cyclic prefix (CP) of the symbols transmitted by the UEs. Symbol repetition is also used for fractional frequency offset estimation in the uplink.

CP auto-correlation is feasible when only a single UE occupies the spectrum. In multiple access systems such as SC-FDMA used in the LTE uplink there are multiple UEs occupying the spectrum. It is therefore necessary for the eNB to perform a fast Fourier transform (FFT) of the multiplexed time domain signal, retain only the subcarriers of interest, set the others to zero and then perform an inverse FFT. In broad band LTE systems this is computationally demanding. In weak signal conditions multiple repetitions of the time domain signal and its CP are required for successful detection.

CFO estimation can also be done by correlating repetitions of data or pilot signals and measuring the correlation phase angle. The repetitions need to be close enough in time that the sampling does not result in aliasing. The time between repetitions defines the maximum resolvable offset frequency. If the CFO can be +/−500 Hz then the samples cannot be more than 1 ms apart. In this method the UEs on different frequencies can be separated and each calculated in the frequency domain.

The 3GPP LTE/LTE-A standards for MTC has initiated the support for coverage enhancement in order to serve MTC devices that are deployed in areas with low/bad network coverage. Such MTC user equipment (UE) will have a very low operating Signal-to-Noise Ratio (SNR). Therefore, in the uplink, the UE has to transmit multiple repetitions of the data block so that it is successfully decoded by the evolved NodeB (eNB). This results in an increased ON time of the UE and hence an increase in the power consumption.

The LTE/LTE-A standardization activities have advocated for narrow-band modes of operation in the uplink to enable energy efficient Internet of Things (IoT). This mode of operation utilizes less than one physical resource block (PRB) and incorporates power spectral density (PSD) boosting to reduce the number of retransmissions and save power. One of the key parameters considered for evaluating the performance of the aforementioned methods is the residual CFO at the eNB. The residual CFO is the amount of frequency offset remaining in the system after detecting and compensating for the initial frequency offset. The smaller the residual CFO, the lesser is the number of retransmissions required by the UE. Therefore, a robust and accurate CFO estimation mechanism at the eNB is desirable. Also, it would be more beneficial if the time and memory taken for an improved CFO estimation mechanism are kept minimal.

Therefore there is a need for a method and system for carrier offset estimation in LTE MTC device communication that is not subject to one or more limitations of the prior art.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and system for carrier frequency offset estimation in LTE machine type communication device communication. In accordance with an aspect of the present invention, there is provided a method for estimating carrier frequency offset (CFO). The method includes receiving redundancy version (RV) repetitions or demodulation reference signal (DMRS) symbols or both and estimating the CFO using maximum likelihood (ML) CFO estimation using information indicative of receipt of the RV repetitions or receipt of the DMRS symbols or receipt of both.

According to some embodiments, receiving includes receiving an increased density of demodulation reference signal (DMRS) symbols and estimating includes estimating the CFO using maximum likelihood (ML) CFO estimation using information indicative of receipt of the increased density of DMRS symbols.

According to some embodiments, receiving includes receiving a burst of demodulation reference symbols (DMRS) symbols and estimating includes estimating the CFO using maximum likelihood (ML) CFO estimation using information indicative of receipt of the burst of DMRS symbols.

According to some embodiments, receiving includes receiving a burst of demodulation reference signal (DMRS) symbols at a beginning of each short burst of sub-frames and estimating includes estimating the CFO using maximum likelihood (ML) CFO estimation using information indicative of receipt of the burst of DMRS symbols.

In accordance with another aspect of the present invention, there is provided a device for estimating carrier frequency offset (CFO). The device includes a processor and machine readable memory storing machine executable instructions. The machine readable instructions, which when executed by the processor configure the device to receive redundancy version (RV) repetitions or demodulation reference signal (DMRS) symbols or both and estimate the CFO using maximum likelihood (ML) CFO estimation using information indicative of receipt of the RV repetitions or receipt of the DMRS symbols or receipt of both.

In accordance with another aspect of the present invention, there is provided a device for enabling estimation of carrier frequency offset (CFO). The device includes a processor and machine readable memory storing machine executable instructions. The machine readable instructions, which when executed by the processor configure the device to determine a CFO estimation method and transmit redundancy version (RV) repetitions or demodulation reference signal (DMRS) symbols or both, based on the CFO estimation method determined.

### BRIEF DESCRIPTION OF THE FIGURES

These and other features of the technology will become more apparent in the following detailed description in which reference is made to the appended drawings.

FIG. 1 illustrates a signal diagram for carrier frequency offset (CFO) estimation in LTE machine type communication (MTC) device communication in accordance with embodiments of the present invention.

FIG. 2 illustrates a cumulative distribution function (CDF) of the estimated CFO error using redundancy version (RV) repetitions for Legacy LTE/LTE-A uplink in accordance with embodiments of the present invention.

FIG. 3 illustrates CDF of the estimated CFO error using RV repetitions for MTC LTE/LTE-A uplink in accordance with embodiments of the present invention.

FIG. 4 illustrates CDF of the estimated CFO error using demodulation reference signal (DMRS) only for both Legacy and MTC LTE/LTE-A uplink in accordance with embodiments of the present invention.

FIG. 5 illustrates CDF of the estimated CFO error using maximum likelihood (ML) estimation using 2× DMRS in accordance with embodiments of the present invention.

FIG. 6 illustrates a current LTE/LTE-A Uplink sub-frame.

FIG. 7 illustrates a MTC DMRS sub-frame and MTC data sub-frame wherein the DMRS is transmitted in a burst in accordance with embodiments of the present invention.

FIG. 8 illustrates a MTC transmission scheme with MTC DMRS and MTC Data sub-frames in accordance with embodiments of the present invention.

FIG. 9 illustrates a CDF of CFO estimation performance of a single uplink tone using the current LTE/LTE-A transmission scheme.

FIG. 10 illustrates a CDF of CFO estimation performance of a single uplink tone using double DMRS density, in accordance with embodiments of the present invention.

FIG. 11 illustrates a CDF of CFO estimation performance of a single uplink tone using a burst of MTC DMRS sub-frames followed by MTC Data sub-frames, wherein P=1 and Q=0 in accordance with embodiments of the present invention.

FIG. 12 illustrates a CDF of CFO estimation performance of a single uplink tone using a burst of MTC DMRS sub-frames followed by MTC Data sub-frames, wherein P=1 and Q=1 in accordance with embodiments of the present invention.

FIG. 13 illustrates RV transmission for LTE/LTE-A MTC uplink in accordance with embodiments of the present invention.

FIG. 14 illustrates a system for carrier frequency offset (CFO) estimation in LTE machine type communication (MTC) device communication in accordance with embodiments of the present invention.

### DETAILED DESCRIPTION

In practice, the demodulation reference signal (DMRS) transmitted by the UE in the uplink are used for CFO estimation. The UE transmits one DMRS symbol every 0.5 ms. Owing to the low operating SNR, the eNB requires multiple repetitions of the DMRS symbols to estimate the CFO with the desired accuracy. The longer it takes for the eNB to estimate the CFO, the more data symbols it has to buffer to apply the CFO correction. Therefore, a novel DMRS transmission method during the initial stage of transmission, which enables faster and more accurate CFO estimation is necessary. This can reduce the number of data retransmissions required by the UE and hence the ON time and power consumption of the UE.

In addition to the DMRS symbols, the redundancy version (RV) repetitions can also be used for CFO estimation. The current LTE/LTE-A standards have retained the same RV cycling order (0,2,3,1) for MTC and proposed an RV repetition scheme with Z=4, where Z indicates the number of consecutive repetitions of the same RV. That is, the RV transmission will follow the pattern 0,0,0,0,2,2,2,2,3,3,3,3,1,1,1,1,0,0,0,0. This method can enable the use of the RV repetition for CFO estimation. Since the duration between RV repetitions is 1 ms, the CFO range that can be detected using this scheme is ±500 Hz. However, this method has been designed for single physical resource block (PRB) transmission, which consists of 12 subcarriers (tones) in each sub-frame for the UE.

For NB-IoT, the number of tones, M, can be less than 12 and in this case, the RV transmission would be such that the 1^{st} sub-frame includes 1 to M subcarriers of RV 0, the 2^{nd} sub-frame includes M+1 to 2M tones of RV 0 and so on. With such a method, the duration between RV repetitions is R=12/M. Then, the maximum CFO range that can be detected using this method reduces to ±(500/R)Hz. For example, when M=1, R=12 and the range of CFO detection reduces to ±41.67 Hz, which can be considered too small since the CFO can be in the order of 100 Hz. Therefore, a modified RV transmission method for NB-IoT is desired.

According to embodiments of the present invention, carrier frequency offset can be determined using a Maximum Likelihood (ML) based CFO estimation using repeated RV transmission or DMRS or a combination of RV transmission and DMRS. In some embodiments, extra DMRS symbols can be added within sub-frames to enhance the effectiveness of these methods of CFO estimation. According to some embodiments, a modified correlation phase angle based CFO estimation method is provided, such that the DMRS symbols can be used to detect CFO within a required range. According to some embodiments, adding more DMRS symbols at least temporarily can be performed in order to achieve the desired CFO performance with the least negative impact on scheduling.

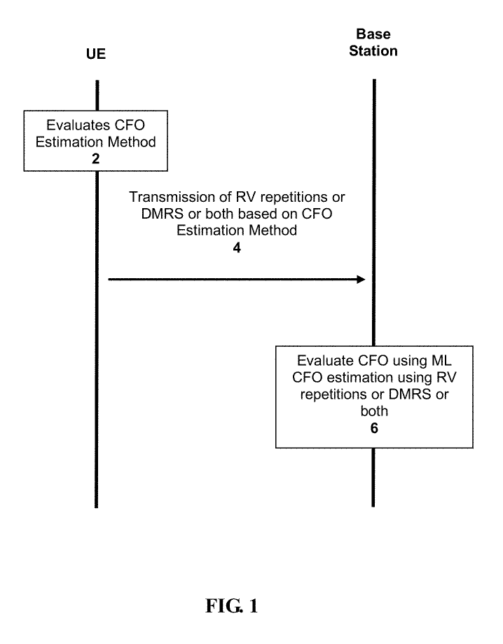

FIG. 1 illustrates a signal diagram for carrier frequency offset (CFO) estimation in LTE machine type communication (MTC) device communication in accordance with embodiments of the present invention. The UE initially determines 2 the CFO estimation method that is being used and upon this determination, the UE, for example an MTC device, a device considered as an Internet of Things (IoT) device or other device, proceeds to transmit 4 RV repetitions or DMRS or both, based on the determined CFO estimation method. Upon receipt of the RV repetitions or DMRS or both, the base station, for example an evolved NodeB (eNB), Node B or similar device, which has information indicative of the CFO estimation method being used, evaluates 6 the CRO using maximum likelihood (ML) CFO estimation using RV repetitions or DMRS or both. Upon this evaluation of the CFO the base station and UE are capable of communication therebetween.

According to embodiments, ML based CFO estimation is performed using repeated data. This method uses the RV repetitions and additional repetitions of each RV if available. According to some embodiments, DMRS is not used because they are not the same between consecutive sub-frames.

According to embodiments, ML based CFO estimation is performed using the DMRS. The DMRS are used as a special case of data repetition. According to embodiments, one DMRS symbol is transmitted each half sub-frame.

According to embodiments, a modified CFO estimation method for DMRS is performed. This method estimates CFO using the phase angle of the correlation of consecutive DMRS symbols.

According to embodiments, ML based CFO estimation is performed using repeated data with DMRS compensation. This method uses all 14 of the symbols in sub-frames by combining ML based CFO estimation using repeated data and a modified CFO estimation scheme for DMRS, which enables the use of the DMRS symbols as well as the data symbols.

### ML Based CFO Estimation Using Repeated Data

According to embodiments, a ML based technique which uses the RV repetitions to estimate the CFO is performed. A new signal x, which comprises N repetitions of the same RV (denoted by r) is defined. For legacy UEs xₚ=r₄ₚ and for MTC UEs, xₚ=rₚ where p=0, 1, . . . N−1.

$${x}_{0} = r {e}^{jm θ} . \\ {x}_{1} = r {e}^{j ( m + LK ) θ} . \\ {x}_{2} = r {e}^{j ( m + 2 LK ) θ} . \\ ⋮ \\ {x}_{N - 1} = {r}_{N - 1} {e}^{j ( m + ( N - 1 ) LK ) θ} . \qquad ( 1 )$$

where L=4 for legacy UEs and L=1 for MTC UEs. When R denotes the SFT of re^{imθ}, then in frequency domain, each RV reception at the base station can be expressed as:

$${Y}_{0} = {H}_{0} \cdot R + {W}_{0} . \\ {Y}_{1} = {H}_{1} \cdot R {e}^{jLK θ} + {W}_{1} . \\ {Y}_{2} = {H}_{3} \cdot R {e}^{j2 LK θ} + {W}_{2} . \\ ⋮ \\ {Y}_{N - 1} = {H}_{N - 1} \cdot {Re}^{j ( N - 1 ) LK ) θ} + {W}_{N - 1} . \qquad ( 2 )$$

where Hᵢ is the channel vector (i=0, 1, . . . N−1), Wᵢ is the noise vector and Hᵢ*R denotes the element-wise multiplication therebetween. The best estimate for H*R is given by:

$$\hat{C} = \frac{1}{N} {\sum }_{n = 0}^{N - 1} {Y}_{n} {e}^{- jnLK θ} \qquad ( 3 )$$

The ML estimator for the phase angle θ, denoted by \hat{θ} and the corresponding CFO estimate (\hat{ε}) are given by:

$$\hat{θ} = {min}_{θ} {\sum }_{n = 0}^{N - 1} {‖ {Y}_{n} - \hat{C} {e}^{jnLK θ} ‖}^{2} . \\ \hat{ε} = \frac{\hat{θ} {N}_{s}}{2 π LK} \qquad ( 4 )$$

### ML Based CFO Estimation Using the DMRS

According to embodiments, a ML based technique which uses the DMRS to estimate the CFO is performed. For DMRS transmission Equation 2 changes to:

$$\begin{matrix}\tilde{{Y}_{00}} = {G}_{00} \cdot {P}_{00} + \tilde{{W}_{0}} 0. \\ \tilde{{Y}_{01}} = {G}_{01} \cdot {P}_{01} {e}^{\frac{j K 0}{2}} + \tilde{{W}_{0}} 1. \\ ⋮ \\ \tilde{{Y}_{N 0}} = {G}_{N 0} \cdot {P}_{N 0} {e}^{\frac{j ( 2 N - 2 ) K ) θ}{2}} + \tilde{{W}_{N 0}} . \\ \tilde{{Y}_{N 1}} = {G}_{N 1} \cdot {P}_{N 1} {e}^{\frac{j ( 2 N - 1 ) K ) θ}{2}} + \tilde{{W}_{N 1}} .\end{matrix} \qquad ( 5 )$$

The channel estimate is given by:

$$\hat{G} = \frac{1}{2 N} {\sum }_{m = 0}^{N - 1} {\sum }_{n = 0}^{1} \tilde{{Y}_{mn}} {P}_{mn}^{*} {e}^{\frac{- j ( 2 m + n ) K θ}{2}}$$

The ML estimator for θ is given by:

$$\hat{θ} = {min}_{θ} {\sum }_{m = 0}^{N - 1} {\sum }_{n = 0}^{1} {‖ \tilde{{Y}_{mn}} - \hat{G} {P}_{mn} {e}^{\frac{j ( 2 m + n ) K θ}{2}} ‖}^{2} .$$

And the corresponding CFO estimate can be calculated using Equation 4 noted above.

### Modified CFO Estimation Scheme for DMRS

According to embodiments, a modified CFO estimation scheme for DMRS is provided. According to embodiments, each received DMRS symbol (Yₘₙ in Equation 5) by the conjugate of the reference DMRS symbol (Pₘₙ) and obtain the CFO estimate by using the phase angle of consecutive DMRS symbols. The CFO estimate is given by:

$$\hat{{ε}_{conv}} = \frac{{N}_{s}}{π K} ( angle ( {\sum }_{l = 1}^{2 N - 1} {Z}_{l} {Z}_{l - 1}^{*} ) )$$

ML Based CFO Estimation Using Repeated Data with DMRS Compensation

According to embodiments, a ML based technique which uses the RV repetitions to estimate the CFO defined above is extended to include the DMRS symbols. This can be performed by multiplying each received DMRS symbol by the conjugate of the reference DMRS symbol. In this manner, all of the DMRS symbols will be a vector of ones, multiplied by the channel co-efficient and the CFO in that symbol plus the noise at the receiver. As such, this will result in 2 additional symbols per sub-frame for ML estimate for CFO.

### Increased DMRS Density

According to embodiments, doubling the density of the DMRS for N initial sub-frames can be beneficial. The DMRS are normally transmitted on the 4^{th} and 11^{th} symbols of a sub-frame. Extra DMRS can be placed on the 3^{rd} and 10^{th} symbols for N sub-frames and after that revert to the legacy DMRS only.

According to embodiments, an improvement in performance can be observed because the noise is averaged 4N times as opposed to 2N times. The performance of the CFO estimation is close to that of the ML based method using RV repetition. However using the RV based method requires a long RV sequence consisting of 32 repetitions for each of the four RVs in order to achieve good CFO estimation performance. In comparison with this the doubled DMRS method does not impose a restriction on the RV block being transmitted and the number of repetitions. The disadvantage of adding extra DMRS is the reduction in the number of available bits in the sub-frames for the control and data packets to 10 from 12 for the duration of the N sub-frames. For example if N=32 there is an overhead of 64 symbols. Since the transmission takes more than 100 sub-frames for any transport block size (TBS), this overhead is less than 5%. In addition to the CFO estimation benefit the base station, for example an evolved NodeB (eNB), Node B or similar device, could use the additional DMRS to improve channel estimation which improves the overall performance of data decoding with a reduction in overhead.

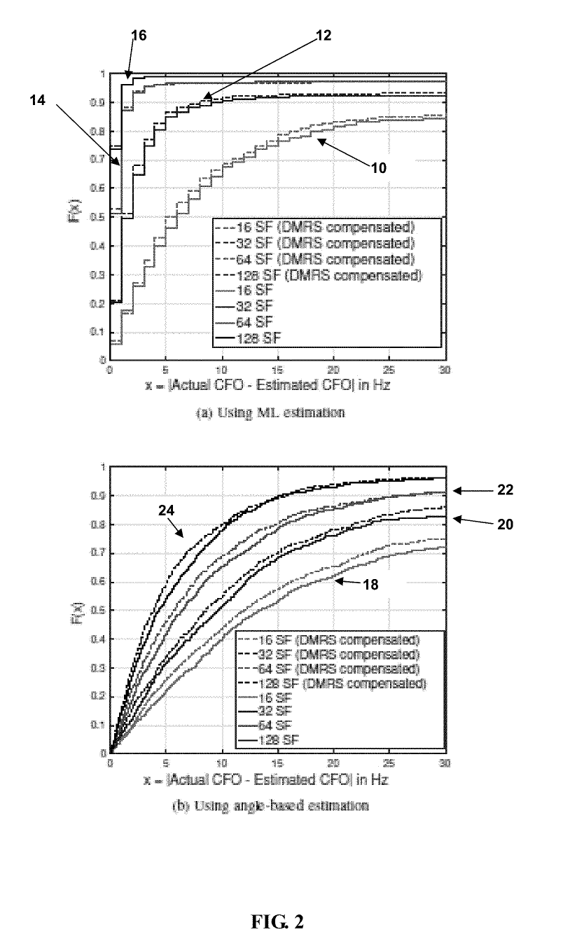

According to embodiments, FIGS. 2 to 5 illustrate how the methods of CFO estimation compare by showing the Cumulative Distribution Function (CDF) for CFO error. Given that 10 Hz error is an objective, it is clear that in all cases using more sub-frames to calculate CDF improves the accuracy. Since the kinds of data traffic that are common for MTC are often small, it may not be necessary to send any more than is necessary to achieve the target performance.

FIG. 2 shows a comparison of the performance of legacy LTE, which has all 12 subcarriers transmitted in an uplink PRB with RV repetition according to embodiments of the present invention. In this case the RVs are sent one per sub-frame in the sequence [0,2,3,1] which is then repeated. Taking 32 sub-frames and a 10% error target as a reference example, it can be seen that ML estimation yields 90% success as shown in FIG. 2(a), wherein this whereas the conventional angle based estimation achieves only 50% as shown in FIG. 2(b). FIG. 2(a) and FIG. 2(b) illustrate results relating to the use of 16 sub-frames (10, 18), 32 sub-frames (12, 20), 64 sub-frames (14, 22) and 128 sub-frames (16, 24). In both cases, including compensated DMRS symbols offers a small improvement, which is illustrated by the dashed lines in FIGS. 2(a) and 2(b).

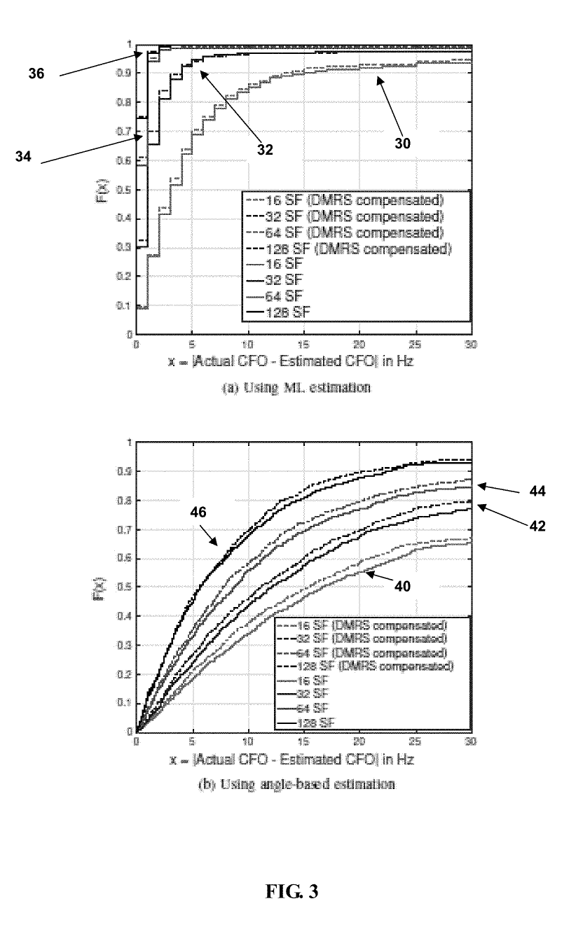

FIG. 3 compares ML estimation and angle-based estimation on RV repetition for the MTC uplink with 12 tones in the uplink according to embodiments of the present invention. Using the same target 10% error and 32 sub-frames ML estimation achieves 95% success as shown in FIG. 3(a) vs. under 50% for conventional angle based estimation as shown in FIG. 3(b). This method sends each RV repeated for the stated number of tones before changing to the next one in the [0,2,3,1] sequence. FIG. 3(a) and FIG. 3(b) illustrate results relating to the use of 16 sub-frames 30, 40), 32 sub-frames (32, 42), 64 sub-frames (34, 44) and 128 sub-frames (36, 46). In both cases, including compensated DMRS symbols offers a small improvement, which is illustrated by the dashed lines in FIGS. 3(a) and 3(b). In addition, the performance of this method is better than the example in FIG. 2 when using ML estimation.

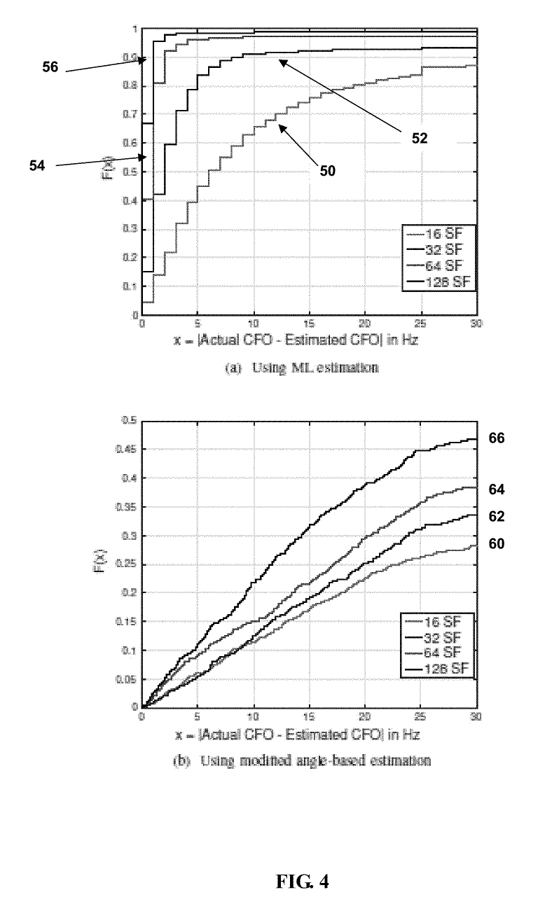

FIG. 4 shows the effect of using only the DMRS with both ML estimation and modified angle based modulation according to embodiments of the present invention. In this case the ML estimation achieves about 80% success (FIG. 4(a)) for 32 sub-frames and 10 Hz CFO error whereas the angle based modulation (FIG. 4(b)) performs very poorly, at 12%, note the “y” axis scale is expanded. FIG. 4(a) and FIG. 4(b) illustrate results relating to the use of 16 sub-frames (50, 60), 32 sub-frames (52, 62), 64 sub-frames (54, 64) and 128 sub-frames (56, 66).

In FIG. 5 it can be seen that the ML estimation together with DMRS doubling achieves 95% success for 10 Hz offset, which is as good as RV repetition according to embodiments of the present invention. FIG. 5 illustrates results relating to the use of 16 sub-frames 68, 32 sub-frames 70, 64 sub-frames 72 and 128 sub-frames 74.

### MTC DMRS and Data Transmission Mechanism for LTE/LTE-A Uplink

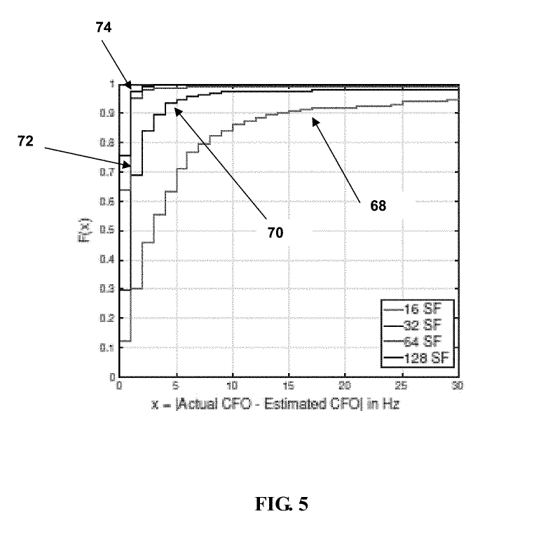

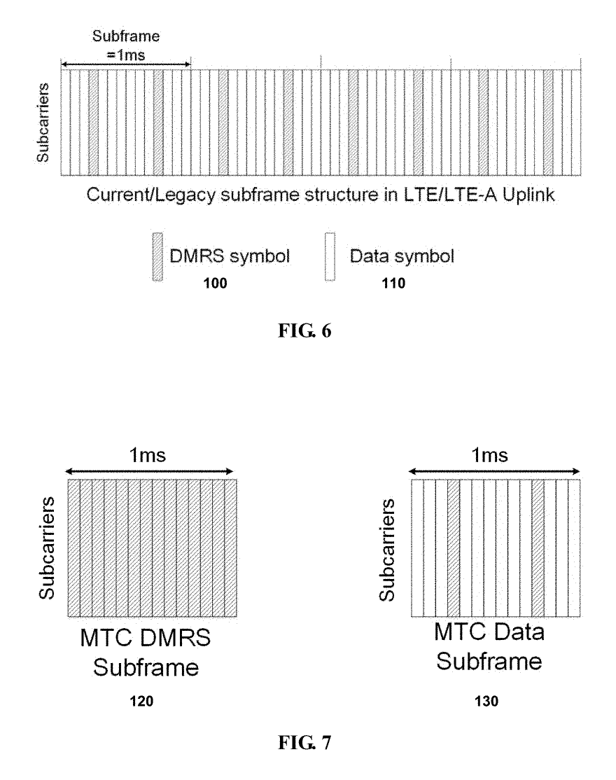

In the current LTE/LTE-A standards for uplink, the DMRS symbol 100 is transmitted on the 4^{th} and the 11^{th} symbol of each sub-frame as shown in FIG. 6 and a data symbol 110 can be transmitted on the remaining.

According to embodiments of the present invention, the DMRS density can be increased for “L” initial sub-frames. In this method, the number of symbols used for DMRS in each sub-frame is increased by a factor “f” and some data symbols are replaced by DMRS symbols. For example, if f=2, the DMRS density is doubled and the 3^{rd} and the 10^{th} symbols can be used for DMRS. Similarly, if f=3, the 2^{nd}, 3^{rd}, 4^{th}, 9^{th}, 10^{th} and 11^{th} symbols can be used for DMRS.

According to embodiments of the present invention, the DMRS can be transmitted in a burst, for example as illustrated in FIG. 7.

According to embodiments, the method of sending DMRS in a burst can include the following steps: the sub-frames are classified into 2 categories as illustrated in FIG. 7, namely MTC DMRS sub-frame 120, which comprises a sub-frame completely filled with DMRS symbols and a MTC Data sub-frame 130, which is configured in line with the current LTE/LTE-A sub-frame in the uplink. In the MTC DMRS sub-frame, each symbol can carry the same or a different known sequence. The sequence can correspond to the currently used Zadoff-Chu sequence or other sequence usable for LTE/LTE-A NB-IoT for pilot transmission in the uplink.

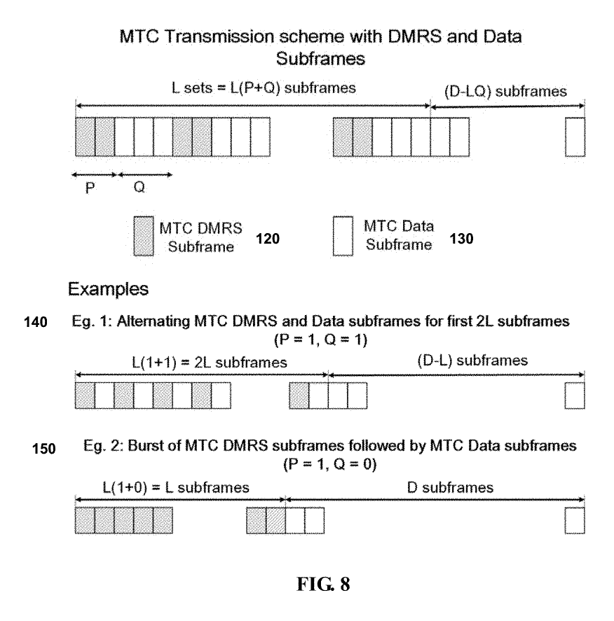

With reference to FIG. 8, the MTC UE requires “D” repetitions of data for successful data decoding at the base station, which corresponds to “D” sub-frames, since each repetition takes one sub-frame in LTE/LTE-A. A “sub-frame set” transmission is defined as a transmission comprising “P” consecutive MTC DMRS sub-frames 120, followed by “Q” consecutive MTC Data sub-frames 130. The MTC UE transmits “L” such sub-frame sets, followed by the remaining (D-QL) MTC data sub-frames as illustrated in FIG. 8. As an example, Eg. 1 140 illustrates the case where if P=1 and Q=0, the method comprises transmission of a burst of L MTC DMRS sub-frames, followed by “D” MTC Data sub-frames. As another example, Eg. 2 150 in FIG. 8 illustrates the case where, if P=Q=1, the method comprises transmission of alternating MTC DMRS and MTC Data sub-frames for the first 2L sub-frames, followed by (D-L) MTC Data sub-frames. These examples are illustrated in FIG. 8. The number of subcarriers used in each sub-frame, M, depends on the implementation. For a single PRB based UE transmission, this value is 12. For NB-IoT, this value corresponds to the number of subcarriers being used for narrow-band transmission such that 1≦M≦12.

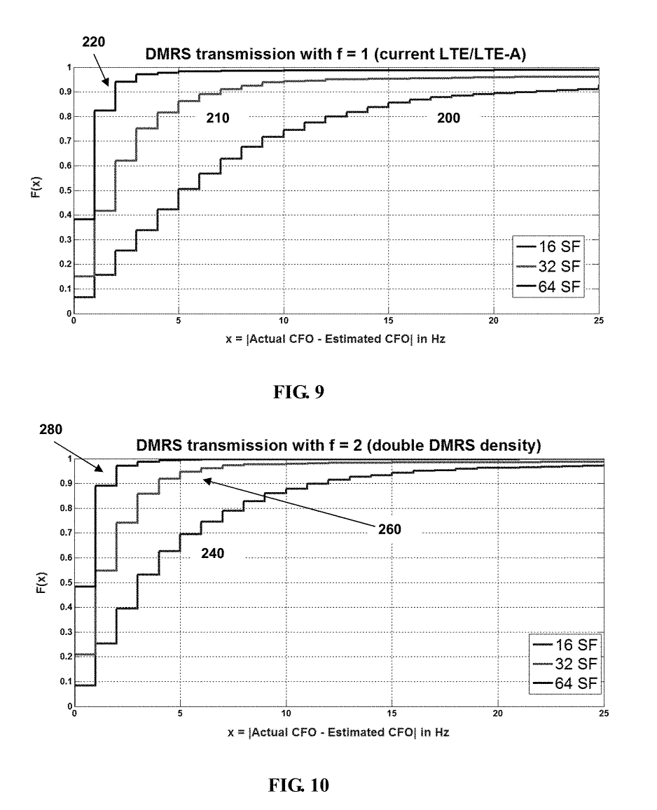

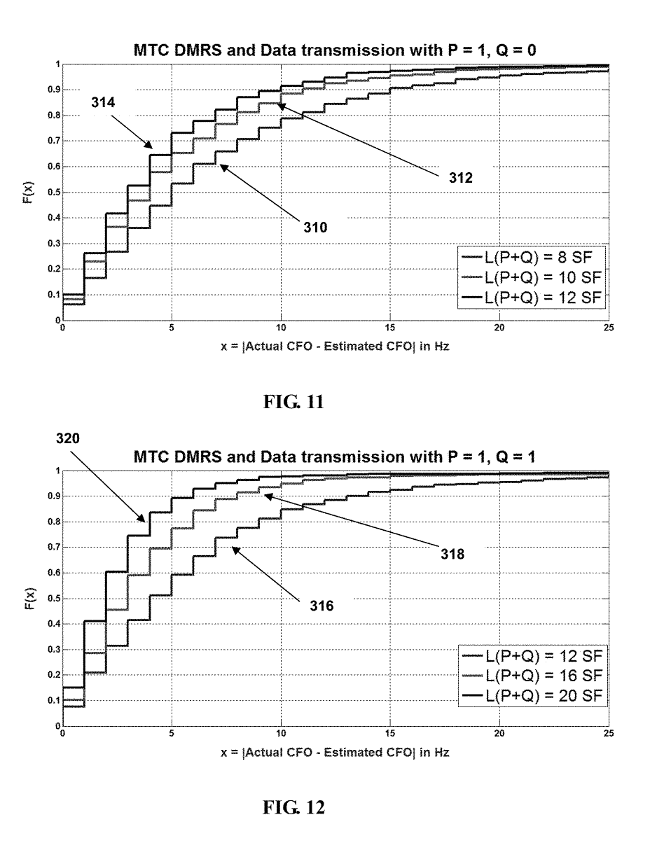

According to embodiments, the performance of CFO estimation in a single tone uplink (M=1) for the DMRS transmission mechanisms by increased DMRS density and burst transmission of DMRS were analyzed through simulations. As a basis for comparison the performance of the legacy DMRS spacing is shown in FIG. 9. In addition, FIG. 9 shows a comparison between the number of sub-frames used, 16 sub-frames 200, 32 sub-frames 210 and 64 sub-frames 220. Increased DMRS density was simulated for f=2 (doubled DMRS density) in FIG. 10. In addition, FIG. 10 shows a comparison between the number of sub-frames used, 16 sub-frames 240, 32 sub-frames 260 and 64 sub-frames 280. Burst transmission of DMRS was simulated for the cases corresponding to two examples, (a) P=1, Q=0 in FIG. 11 and (b) P=Q=1 in FIG. 12. In addition, FIG. 11 shows a comparison between the number of sub-frames used, 8 sub-frames 310, 10 sub-frames 312 and 12 sub-frames 314. FIG. 12 shows a comparison between the number of sub-frames used, 12 sub-frames 316, 16 sub-frames 318 and 20 sub-frames 320.

According to embodiments, the settings for the above defined simulations as shown in FIG. 11 and FIG. 12, are summarized as follows: Number of subcarriers, M=1; SNR=−17.5 dB (corresponding to 20 dB coverage enhancement); Number of UE antennas=1, Number of base station antennas=2; Channel Model Used=Extended Pedestrian A (EPA), Doppler shift=1 Hz and CFO to be estimated=100 Hz. According to embodiments, the method used for CFO detection is based on Maximum Likelihood (ML) estimation tailored to the LTE/LTE-A MTC frame structure, as discussed in further detail elsewhere herein. The metric used for measuring the performance of the solutions (increased DMRS density and burst transmission of DMRS) is the number of sub-frames, D, taken to achieve a CFO accuracy within 10 Hz, with at least 90% probability (x=10 Hz, F(x)=0.9). The value of D indicates the number of sub-frames that have to be buffered by the base station to estimate the CFO with the desired accuracy. The solutions with smaller values for D are better. The results are summarized in TABLE 2. Both of the solutions result in lower values of D, when compared to the current MTC uplink method in LTE/LTE-A. According to embodiments, the P=1, Q=1 DMRS scheme (alternating DMRS burst and data sub-frames) may be considered superior as this method data may not be blocked for long and CFO estimation performance may also not take as long.

TABLE 2

| Transmission Mechanism | D |
|---|---|
| Current LTE/LTE-A MTC | 32 |
| Increase DMRS Density: Double DMRS density | 24 |
| DMRS Burst: P = 1, Q = 0 | 12 |
| DMRS Burst: P = 1, Q = 1 | 16 |

According to embodiments, the best method for CFO estimation for NB-IoT can also be determined based on additional constraints and optimisations.

According to embodiments, it is desired to achieve quick and reliable CFO and channel estimation in an operating scenario of short intermittent Narrrowband Physical Uplink Shared Channel (NPUSCH) data transmissions in which each burst may require an independent CFO and channel estimate.

According to embodiments, in order to avoid one UE blocking access by other UEs it will be preferable to schedule long transmissions in sections, with gaps in time to allow the scheduling of other UEs to use the uplink (UL) resource. Doing this also adds the advantage of additional time diversity, which is a technique which can improve the error performance of the communications channel when there is fading.

According to embodiments, the implementation of NB-IoT will be half duplex operation, wherein the UE will not transmit and receive at the same time. One consequence of this half duplex operation is that the UE will need to re-establish synchronisation with the base station in frequency (CFO) and symbol timing periodically.

According to embodiments, the CFO needs to be evaluated for each burst of transmission. The duration of a burst can be 64 or 128 sub-frames, which means that the presence of DMRS symbols in legacy transmission will not provide enough information alone. This type of operation in short bursts can work best with the option of a burst of continuous DMRS sub-frames at the beginning of each burst.

### RV Transmission for NB-IoT

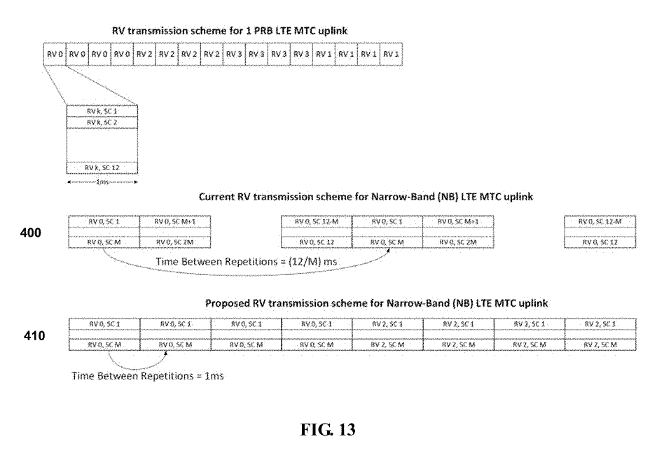

According to embodiments, the RV transmission method includes tones corresponding to the RVs being transmitted such that the time between the repetitions is 1 ms. This can be achieved by transmitting tones 1 to M of RV 0 on the first sub-frame, a repetition of the same on the 2^{nd}, 3^{rd} and 4^{th} sub-frames. Similarly, the 5^{th}, 6^{th}, 7^{th} and 8^{th} sub-frames can comprise tones 1 to M of RV 2 and so on as shown in FIG. 13. For the current scheme with M=1, each RV transmission will take (12/M)=12 ms. Therefore, the transmission of four RV 0 copies takes 4×12=48 ms. This transmission time remains substantially the same for the proposed RV transmission method.

The following is an example of RV transmission for NB-IoT in accordance with embodiments of the present invention.
Let us take the sub-frame matrix
[a_0_0 a_0_1 . . . a_0_13--->row1
a_1_0 a_1_1 . . . a_1_13--->row2
[a_11_0 a_11_1 . . . a_11_13]--->row12
where a_m_n denotes the data transmitted on tone ‘m’, symbol ‘n’.

Case 1: If we take one tone transmission, M=1.

Then in the current scheme, the first four RV transmissions (corresponding to RV pattern 0000222233331111) would look like
<row1, row2, . . . row14>, <row1, row2, . . . row14>, <row1, row2, . . . row14>, <row1, row2, . . . row14>
where each row takes 1 ms and the content in < > is worth one RV, which will take 12 ms if M=1. The time between repetitions is 12 ms and it takes 48 ms to send the four RVs. Therefore, the CFO range that can be detected is +/−(500/12) Hz.
In the proposed scheme, we send
row1, row1, row1, row1, row2, row2, row2, row2, . . . row14, row14,row14,row14
This also takes 48 ms. But the time between RV repetitions is 1 ms and CFO range that can be detected is +/−500 Hz.
Case 2: M=2
Current scheme will be row_1_2, row_3_4, row_5_6, row_7_8, row_9_10, row_11_12, row_1_2, row_3_4, row_5_6, row_7_8, row_9_10, row_11_12, row_1_2, row_3_4, row_5_6, row_7_8, row_9_10, row_11_12, row_1_2, row_3_4, row_5_6, row_7_8, row_9_10, row_11_12.
row_m_n=[row_m on first tone
   row_n] on second tone
The tie between repetitions is 12/M=12/2=6 ms. For example, row_1_2 is sent on first and sixth sub-frames. The CFO range that can be detected is +/−(500/6) Hz.
For Case 2: M=2
Proposed scheme will be
row_1_2, row_1_2, row_1_2, row_1_2, row_3_4, row_3_4, row_3_4, row_3_4, row_5_6, row_5_6, row_5_6, row_5_6, row_7_8, row_7_8, row_7_8, row_7_8, row_9_10, row_9_10, row_9_10, row_9_10, row_11_12, row_11_12, row_11_12, row_11_12.
Therefore, the time between repetitions=1 ms, CFO range=+/−500 Hz.

FIG. 13 illustrates RV transmission for LTE/LTE-A MTC uplink for both current RV transmission 400 and the RV transmission for NB LTE MTC uplink 410 in accordance with embodiments of the present invention.

In light of the above example, RV repetition may not be as good as DMRS burst transmission since there are only 4 consecutive repetitions of the same RV (referred as Z=4). However, if Z=16 or 32, RV repetition may approach the estimation capabilities of the DMRS burst transmission.

In accordance with embodiments of the present invention, the ML based CFO estimation method is provided below:
Let z₀ denote the transmitted signal of length S samples. The CFO of the UE is denoted by ε. Since the CFO is a phase-ramp in time-domain, the signal with CFO is given by

$$z = {z}_{0} {e}^{( \frac{j 2 πε m}{{N}_{s}} )} .$$

where m=0, 1, . . . S−1 and Nₛ, is the sampling rate. The phase angle corresponding to the CFO is defined as:

$$θ = \frac{2 πε}{{N}_{s}} .$$

Then, the transmitted signal with CFO can be expressed as:

$$z = {z}_{0} {e}^{jm θ} .$$

ML Based CFO Estimation Using RV Repetition
The RV r has a length of K samples and one RV is transmitted per sub-frame. Each RV transmission in time-domain can be expressed as:

$$\begin{matrix}{x}_{0} = {re}^{jm θ} , \\ {x}_{1} = {re}^{j ( m + K ) θ} , \\ {x}_{2} = {re}^{j ( m + 2 K ) θ} . \\ ⋮ \\ {x}_{N - 1} = {re}^{j ( m + ( N - 1 ) K ) θ} .\end{matrix}$$

where N is the number of RV repetitions (=number of sub-frames). Let R denote the Discrete Fourier Transform (DFT) of re^{jmθ}.

Then, in frequency domain, each RV reception at the base station can be expressed as:

$$\begin{matrix}{Y}_{0} = {H}_{0} \cdot R + {W}_{0} . \\ {Y}_{1} = {H}_{1} \cdot {Re}^{jK θ } + {W}_{1} . \\ {Y}_{2} = {H}_{2} \cdot {Re}^{j 2 K θ } + {W}_{2} . \\ ⋮ \\ {Y}_{N - 1} = {H}_{N - 1} \cdot {Re}^{j ( N - 1 ) K ) θ} + {W}_{N - 1} .\end{matrix}$$

where Hᵢ is the channel vector (i=0, 1, . . . , N−1), Wᵢ is the noise vector and Hᵢ,R denotes the element-wise multiplication between Hᵢ and R.

Assuming that the channel remains the same for N sub-frames, which holds in the case of pedestrian channels, Hᵢ=H for all i. Since we have no information about the data and the channel, the best estimate for the vector Hᵢ,R is given by:

$$\hat{C} = \frac{1}{N} {\sum }_{n = 0}^{N - 1} {Y}_{n} {e}^{- jnK θ}$$

Therefore, the ML estimator for θ is designed as:

$$\hat{θ} = {min}_{θ} {\sum }_{n = 0}^{N - 1} {‖ {Y}_{n} - \hat{C} {e}^{jnK θ} ‖}^{2} .$$

ML Based CFO Estimation Using DMRS

In the special case when the transmitted data is known, such as the DMRS in the uplink, one DMRS sequence is transmitted every 0.5 ms in current LTE/LTE-A and the received DMRS at the base station can be expressed as:

$$\begin{matrix}{\tilde{Y}}_{0} = {G}_{0} \cdot {P}_{0} R + {\tilde{W}}_{0} . \\ {\tilde{Y}}_{1} = {G}_{1} \cdot {P}_{1} {e}^{\frac{j K θ}{2} } + {\tilde{W}}_{1} . \\ {\tilde{Y}}_{2} = {G}_{2} \cdot {P}_{2} {e}^{\frac{j 2 K θ}{2} } + {\tilde{W}}_{2} . \\ ⋮ \\ \tilde{{Y}_{2 N - 1}} = {G}_{N - 1} \cdot {P}_{N - 1} {e}^{\frac{j ( N - 1 ) K ) θ}{2}} + \tilde{{W}_{N - 1}} .\end{matrix}$$

where P₀, P₁, . . . , P_{2N-1} are the “known” DMRS sequences, Gi and \tilde{W} are the channel and the noise vectors (i=0, 1, . . . , N−1).
Assuming that the channel remains constant over N sub-frames, the channel estimate is given by:

$$\hat{G} = \frac{1}{2 N} {\sum }_{n = 0}^{2 N - 1} \tilde{{Y}_{n}} {P}_{n}^{*} {e}^{\frac{- jnK θ}{2}}$$

and the ML estimator for θ is given by:

$$\hat{θ} = {min}_{θ} {\sum }_{n = 0}^{N - 1} {‖ \tilde{{Y}_{n}} - \hat{G} {P}_{n} {e}^{\frac{jnK θ}{2}} ‖}^{2} .$$

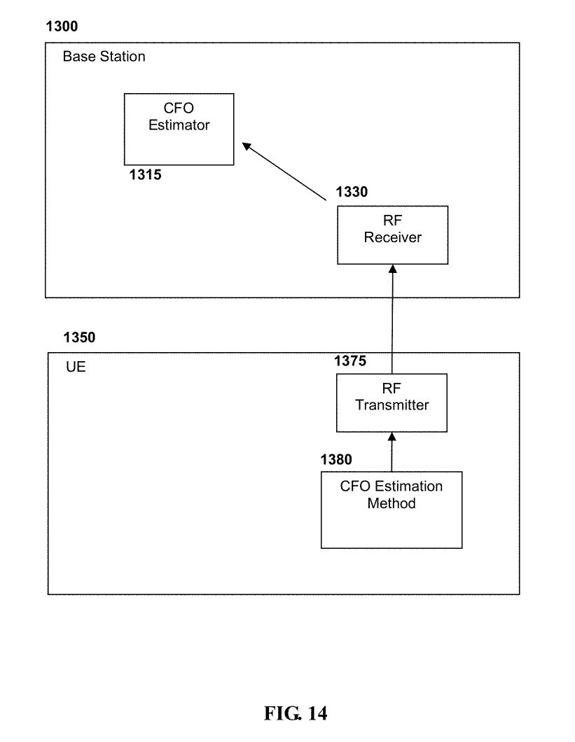

According to embodiments, a system for carrier frequency offset (CFO) estimation in LTE machine type communication (MTC) device communication is shown in FIG. 14. The system includes a user equipment 1350 (UE) which can be an MTC device, a device considered as an Internet of Things (IoT) device or other device. The UE includes information indicative of the CFO estimation method 1380, which can be stored in memory thereon. Using this CFO estimation method 1380, the UE transmits via the transmitter 1375 information to the base station 1300, for example an evolved NodeB (eNB), Node B or similar device. The base station receives the information as the receiver 1330 and forwards this information to the CFO estimator 1315, which determines or knows the CFO estimation method, and proceeds to determine the CFO using the appropriate CFO estimation method. It will be readily understood that the CFO method implemented within the system can be configured as one or more of the methods of CFO estimation discussed elsewhere herein.

It will be appreciated that, although specific embodiments of the technology have been described herein for purposes of illustration, various modifications may be made without departing from the spirit and scope of the technology. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

Although the present invention has been described with reference to specific features and embodiments thereof, it is evident that various modifications and combinations can be made thereto without departing from the invention. Moreover, in some instances the present invention has been described using reference to terminology specific to LTE, it is readily understood that the use of these terms is meant to be illustrative and not limiting. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for estimating carrier frequency offset (CFO), the method comprising:
receiving redundancy version (RV) repetitions or demodulation reference signal (DMRS) symbols or both;
estimating the CFO using maximum likelihood (ML) CFO estimation using information indicative of receipt of the RV repetitions or receipt of the DMRS symbols or receipt of both.

2. The method according to claim 1, wherein receiving includes receiving an increased density of demodulation reference signal (DMRS) symbols and estimating includes estimating the CFO using maximum likelihood (ML) CFO estimation using information indicative of receipt of the increased density of DMRS symbols.

3. The method according to claim 1, wherein receiving includes receiving a burst of demodulation reference symbols (DMRS) symbols and estimating includes estimating the CFO using maximum likelihood (ML) CFO estimation using information indicative of receipt of the burst of DMRS symbols.

4. The method according to claim 1, wherein receiving includes receiving a burst of demodulation reference signal (DMRS) symbols at a beginning of each short burst of sub-frames and estimating includes estimating the CFO using maximum likelihood (ML) CFO estimation using information indicative of receipt of the burst of DMRS symbols.

5. The method according to claim 4 wherein gaps between bursts of DMRS symbols sent by a first transmitter are used by a second transmitter to send a burst of DMRS symbols associated with the second transmitter.

6. A device for estimating carrier frequency offset (CFO), the device comprising:
a processor; and
machine readable memory storing machine executable instructions which when executed by the processor configure the device to:
receive redundancy version (RV) repetitions or demodulation reference signal (DMRS) symbols or both;
estimate the CFO using maximum likelihood (ML) CFO estimation using information indicative of receipt of the RV repetitions or receipt of the DMRS symbols or receipt of both.

7. The device according to claim 6, wherein the machine readable instructions configure the device to receive an increased density of demodulation reference signal (DMRS) symbols and estimate the CFO using maximum likelihood (ML) CFO estimation using information indicative of receipt of the increased density of DMRS symbols.

8. The device according to claim 6, wherein the machine readable instructions configure the device to receive a burst of demodulation reference symbols (DMRS) symbols and estimate the CFO using maximum likelihood (ML) CFO estimation using information indicative of receipt of the burst of DMRS symbols.

9. The device according to claim 6, wherein the machine readable instructions configure the device to receive a burst of demodulation reference signal (DMRS) symbols at a beginning of each short burst of sub-frames and estimate the CFO using maximum likelihood (ML) CFO estimation using information indicative of receipt of the burst of DMRS symbols.

10. The device according to claim 9 wherein gaps between bursts of DMRS symbols sent by a first transmitter are used by a second transmitter to send a burst of DMRS symbols associated with the second transmitter.

12. A device for enabling estimation of carrier frequency offset (CFO), the device comprising:
a processor; and
machine readable memory storing machine executable instructions which when executed by the processor configure the device to:
determine a CFO estimation method;
transmit redundancy version (RV) repetitions or demodulation reference signal (DMRS) symbols or both, based on the CFO estimation method determined.

13. The device according to claim 12, wherein the device is a machine type communication (MTC) device or an Internet of Things (IoT) device.
